(19) United States
(12) Patent Application Publication
(10) Pub. No.: US 2008/0069987 A1
(43) Pub. Date: Mar. 20, 2008

(54) SAFETY AND PROTECTION SEAL ARRANGEMENT FOR FOODSTUFF AND BEVERAGE PACKING

(76) Inventor: Francisco Amante, Sao Paulo/SP (BR)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/533,681

(22) Filed: Sep. 20, 2006

(51) Int. Cl. F16B 4/00

(52) U.S. Cl. 428/34.9

(57) ABSTRACT

“SAFETY AND PROTECTION SEAL ARRANGEMENT FOR FOODSTUFF AND BEVERAGE PACKING”, more particularly referring to a heat shrinkable seal (1) applied to the opening or mouthpiece region (B) of packing (E), preferably for direct consumption foodstuff and beverages, said heat-shrinkable seal (1) comprising a heat-shrinkable material tubular portion (2), sized such as to totally or partially involve the packing, more precisely the packing mouthpiece (B), which tubular portion (2), after being placed on the packing is heat-shrunk defining a top collar (3) flat and parallel to the cap (T) of packing (E), defining an annular support surface for the sealability (4) of a disk-shaped seal (5); the band (2) being provided with means to rupture the seal (1) with or without ribbon (6) and partial perforation.

### FIELD OF THE INVENTION

This utility model relates to a new arrangement in security and tamper-resistant (tamper-evident) seals for foodstuff and beverage packing, more particularly to can-type packing made in aluminum, stainless steel, plastic or other material and intended for packing human and animal consumption products, mainly those for direct consumption, such as beverages or foodstuff. This heat-shrinkable seal comprises a tubular band which is thermally fitted around the packing opening portion and receives a disk-shaped seal complementary to the top closure, such a disk-shaped seal being welded to the band through thermal, sizing or other proper means, whereby the mouth of the package is thoroughly kept away from any contact with the environment.

### BACKGROUND OF THE INVENTION

As is well known, the number of food and beverage products manufactured for direct consumption is increasing daily. Many foodstuff and beverage corporations have been engaged in creating the best type of packing for their products and how to best preserve such products until they reach the consumer in the best and appropriate conditions.

This occurs with disposable beverage cans, pickled food cans and so many others, where the consumer, generally as a habit or by distraction, opens the package metal pull tab readily initiating the consumption of the product, as is usual with cans used to pack soft drinks, beer, energetic juices, etc., or even canned sardine, tuna, pea, corn and other plastic packages for yogurts, jellies, etc.

A lot has been said regarding the need to provide means to protect the top surface of the packages, whereby to reduce the possibility of accumulating impurities, since, as is known, direct consumer product distributors, such as restaurants, bars, supermarkets, wholesalers and countless others, maintain the goods stocked in spaces or refrigerators usually under minimal conditions of hygiene, permitting that, mainly canned products, are subject to all types of settling of impurities, coming either from circulating dust, or from the various animal species, such as rats and insects, since it is known that they deposit residues which transform into fungi and bacteria, most of which generally settle at the top surface of the stocked packing either during storage, or at a reseller's display or even in compartments in home storage and in shops in general.

Very few consumers worry to wipe around the pouring opening before drinking the liquid or pouring the product and, thus, for this reason, many diseases are acquired without even their origin being established, the diseases, depending on the bacteria, being even lethal. Based on the above and having in view to call the population's attention to the need to hygienize the packing before immediate consumption, some makers sell their products with seals which, basically, can assume the following two types of embodiments: a) the type like an aluminum sheet which covers the top surface of and side neck of the beverage can mouthpiece, and b) a thermoplastic sealing material, constituted basically of a band which, heat-shrinked, involves the double-seamed part of the beverage or foodstuff can, further to a small top part of the lid.

Despite representing an improvement over the entire lack of protection means, both the prior art seals present several inconveniences, such as, for instance, the aluminum seal does not adhere suitably to the can mouthpiece, detaching easily from the can and tearing through friction during loading and transportation further to deforming with extreme facility, creating a favorable environment for the settling of impurities and all sorts of bacteria and fungi.

On the other hand, the thermoplastic seal is directed more particularly to screw-on caps, acting as anti-taper seals, since when applied to cans in general, they are not satisfactorily efficient, since, the top double-seam of the aluminum, steel, glass, tin, etc. can forms a step relative to the cap, hindering the thermoplastic seal to completely seal the mouthpiece, and further, constitutes a favorable means of accumulation for moisture and mites, ideal for the proliferation of fungi, acting more as a seal.

Other similar seals have already been developed, however most of them are inefficient or are expensive, hindering their incorporation to beverage cans and other canned products.

Hence, one notices that the protection offered nowadays does not avoid contamination, leaving it to the consumer to clean the mouthpiece before consuming the beverage or foodstuff.

### SUMMARY AND OBJECTS OF THE INVENTION

In order to eliminate the above-mentioned shortcomings, the applicant developed a novel arrangement for a heat-shrinkable seal applied to beverage and foodstuff packing, such constructive features allowing that it be applied to any type of packing closure, be it a double-seamed can, or screw-on caps, with aluminum seals and the like, where the added cost to the final product is minimal and brings immediate benefit to the consumer; the novel heat-shrinkable seal is easily incorporated to the productive process of any canned product, since it comprises a tubular portion which involves the mouthpiece of the packing, which portion is heat-shrinked resulting in a top collar that receives, as an airtight closure, a disk-shaped seal.

The tubular band which comprises the coating of the mouthpiece of the packing is made from a shrinkable material, such as PVC, PET, BOPP. Nylon or the like, a ribbon being or not provided to help opening the seal body or otherwise a partially or entirely perforated line acting with the same function as the ribbon.

The top closing disk can be made from several materials, depending on the welding operation (by heat or peripheral adhesive) to be applied to the collar formed on the band after the heat-shrinkage of the tubular band around the forming substrate; the preferred substances are cellulose, aluminum, BOPP, PVC, Polystyrene and the like. Both the band and the seal made as two or more layer laminated substrates.

After applying the heat-shrinkable seal of the invention, the entire mouthpiece of the packing is entirely isolated from any contact with the outer environment, allowing that the consumer acquire a product for immediate consumption without the risk of contamination, since the impurities coming from storage do not settle on the packing mouthpiece.

Any of the parts which compose the heat-shrinkable seal, i.e., the tubular body or the closing disk may contain promotional images and information, or the like, and, inclusive, can further be opaque, colored, translucent or printed.

For better hygiene conditions of the packing, it can be provided that before applying the novel heat-shrinkable seal, the packing pass through a conventional sterilization step, further assuring additional consumer protection.

### DESCRIPTION OF THE DRAWINGS

In order to provide a better understanding of the features of the utility model and according to a preferred embodiment thereof, the disclosure is accompanied by the drawings hereunder wherein, by means of example, but not limited thereto, the following is represented:

FIG. 1 is a perspective exploded view of the elements which constitute the heat-shrinkable seal in relation with a discardable aluminum can or the like;

FIG. 2 illustrates a can with the band already applied and heat-shrinked, whereas the disk is exploded, before the application of welding;

FIG. 3 depicts a heat-shrinkable seal entirely applied with the disk hermetically enclosing the packing;

FIG. 3A illustrates a possible constructive variation, the can being entirely enclosed by the protection seal;

FIG. 4 shows a sectional side view of the previous figure and an enlarged detail illustrating the heat-shrinkable seal and its details; and

FIGS. 5 and 6 illustrate the application of the novel seal to other models of cans and or other packing items.

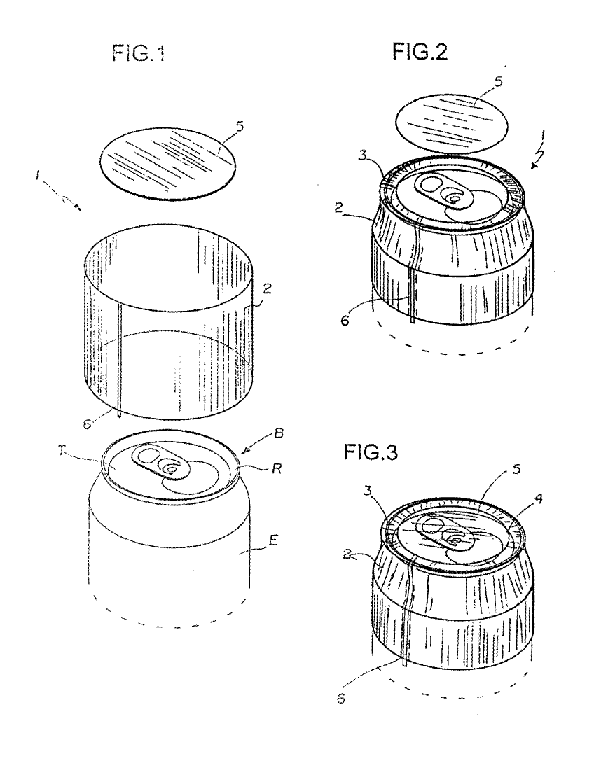

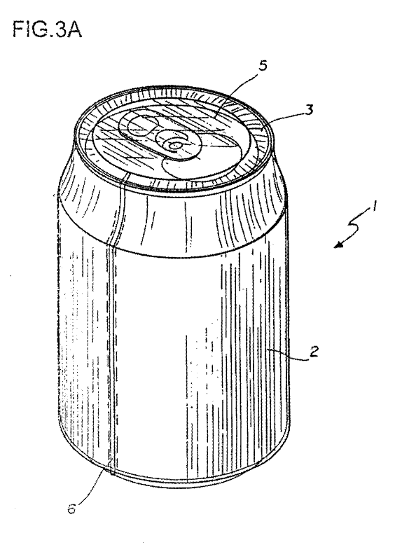

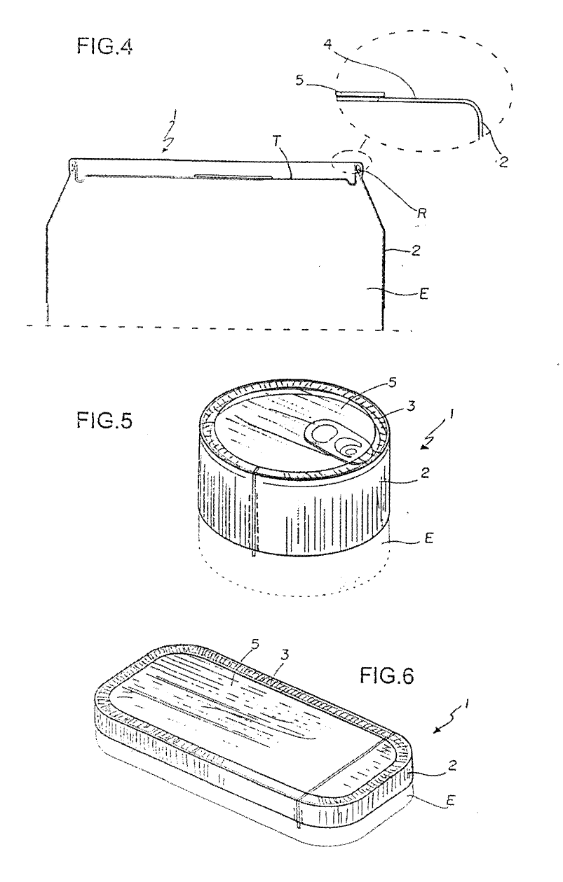

### DETAILED DESCRIPTION OF THE INVENTION

With reference to the illustrated drawings, the present utility model refers to a “SAFETY AND PROTECTION SEAL ARRANGEMENT FOR FOODSTUFF AND BEVERAGE PACKING” and, more particularly, refers to a heat-shrinkable seal (1) applied to the opening or mouthpiece (B) of a packing (E), preferably for prompt consumption foodstuff.

According to the present utility model, heat-shrinkable seal (1) comprises a tubular portion (2) of heat-shrinkable material, sized such as to entirely or partially involve the packing, more precisely mouthpiece (B) of the packing, which tubular portion (2), after being positioned around the packing, is heat-shrinked defining a top collar (3) flat and parallel to cap (T) of packing (E), defining an annular support surface for the welding (4) of a disk-shaped seal (5).

The heat-shrinkable material from which tubular band (2) is made is preferably of the PVC-, PET-, BOPP-, Nylon-type or the like, being it provided with or without a ribbon (6) to aid in extracting seal (1), or further with a partially perforated line acting in the same way as the ribbon.

The top closing disk (5) can be made from several materials, depending on the welding (4) operation, which can be through heat or a self-adhesive substrate applied to collar (3) formed on band (2) after the heat-shrinking thereof around packing (E); the preferred materials applied to disk (5) are cellulose, aluminum, BOPP, PVC, Polystyrene or the like.

Both band (2) and disk (5) may be made as two- or more-layered laminate substrates.

The present heat-shrinkable seal can easily be incorporated to the productive process of any canned product, wherein, advantageously, the constructive features thereof permit that the same be applied to any type of packing enclosure, be it a double-seamed (R), screw-capped, aluminum-capped can or the like, where the cost added to the final product is negligible and the benefit to the consumer is immediate.

I claim:

1. “SAFETY AND PROTECTION SEAL ARRANGEMENT FOR FOODSTUFF AND BEVERAGE PACKING”, more particularly referring to a heat shrinkable seal (1) applied to the opening or mouthpiece region (B) of packing (E), preferably for direct consumption foodstuff and beverages, wherein the heat-shrinkable seal (1) comprises a heat-shrinkable material tubular portion (2), sized such as to totally or partially involve the packing, more precisely the packing mouthpiece (B), which tubular portion (2) , after being placed on the packing is heat-shrunk defining a top collar (3) flat and parallel to the cap (T) of packing (E), defining an annular support surface for the sealability (4) of a disk-shaped seal (5); the band (2) being provided with means to rupture the seal (1) with or without ribbon (6) and partial perforation.

2. “SAFETY AND PROTECTION SEAL ARRANGEMENT FOR FOODSTUFF AND BEVERAGE PACKING”, according to claim 1, wherein the heat-shrinkable material which constitutes the tubular band (2) is of the substrate type, such as: PVC, PET, BOPP, Nylon or the like.

3. “SAFETY AND PROTECTION SEAL ARRANGEMENT FOR FOODSTUFF AND BEVERAGE PACKING”, according to claim 1, wherein the top closing disk (5) comprises the possibility of making the substrate from cellulose, aluminum, BOPP, PVC, Polystyrene and the like.

4. “SAFETY AND PROTECTION SEAL ARRANGEMENT FOR FOODSTUFF AND BEVERAGE PACKING”, according to claim 1, wherein both the band (2) and the disk (5) may be made as two- or more-layered laminate substrates.

5. “SAFETY AND PROTECTION SEAL ARRANGEMENT FOR FOODSTUFF AND BEVERAGE PACKING”, according to claim 1, wherein the heat-shrinkable seal is incorporated to the productive process of any canned product.

6. “SAFETY AND PROTECTION SEAL ARRANGEMENT FOR FOODSTUFF AND BEVERAGE PACKING”, according to claim 1, wherein the heat-shrinkable seal is applicable to any packing closure, be they cans made with double-seams (R), screwed-on caps, aluminum caps and the like.
